(19) United States
(12) Patent Application Publication
(10) Pub. No.: US 2020/0254602 A1
(43) Pub. Date: Aug. 13, 2020

(54) COVER

(71) Applicant: Roberto Martinez, Chicago, IL (US)

(72) Inventor: Roberto Martinez, Chicago, IL (US)

(21) Appl. No.: 16/269,777

(22) Filed: Feb. 7, 2019

(51) Int. Cl. B25G 1/10; A45F 5/00

(52) U.S. Cl. CPC B25G 1/10; A45F 2200/0591; A45F 2200/0575; A45F 5/00

(57) ABSTRACT

The present invention relates to a cover. The cover comprises a cover portion, wherein the cover portion is a sheet of a fire resistant material, and a fastening portion provided on the cover portion for fastening the cover on an appliance. In an embodiment, wherein the fastening portion comprises at least one fastening means, which can be hook and loop straps. In an embodiment, the fastening portion is provided along at least a section of the cover portion periphery. The cover further comprises a cushioning means disposed on the cover portion, wherein the cushioning means is made of at least one of foam and rubber.

### BACKGROUND OF THE INVENTION

### 1. Field of the Invention

The present disclosure relates to the field of protective covers. In particular, the present disclosure relates to a protective cover that can be applied to any appliance.

### 2. Description of the Related Art

Protective covers are known in the art. One purpose of a protective cover is to protect an appliance from scratches, which can spoil the surface finish of the appliance, thereby hampering aesthetics of the appliance. This is not desired.

Several designs for protective covers have been designed in the past. None of them, however, are known to have been specifically designed to be applied on a variety of components or appliances for protecting the surface finish of the appliance and improving the grip on the appliance for the user, while having a long service life and a simple to assemble configuration.

Applicant believes that a related reference corresponds to U.S. Patent Publication No. 20040031128 filed by SHENG-JEN CHEN. The Chen reference discloses a handle grip structure that includes an elastic tube, and an impregnated polyurethane layer mounted on an outer periphery of the elastic tube by a predetermined working process, so that the polyurethane layer are integrally formed on the elastic tube, thereby forming an integral structure. However, handle grip structure disclosed in the Chen reference fails to disclose a cover designed to be applied to a variety of components or appliances, while having a long service life and a simple to assemble configuration.

Applicant believes that another related reference corresponds to U.S. Patent Publication No. 20030053203 filed by PETER STROBEL & FRITZ SOLLBERGER. The Strobel reference discloses a hand-grip with a grip part which can be detachably fastened on a microscope housing, the mounting and dismounting being possible with a single-handed movement with the gripping hand. The hand-grip is fashioned and positioned such that it permits operation of the microscope in all directions with only one hand. However, the hand-grip disclosed in the Strobel reference fails to disclose a configuration suitable to be applied to a variety of components or appliances for protecting the surface finish of the appliance and improving the grip on the appliance for the user, while having a long service life and a simple to assemble configuration.

Other documents describing the closest subject matter provide for a number of more or less complicated features that fail to solve the problem in an efficient and economical way. None of these patents suggest the novel features of the present invention.

### SUMMARY OF THE INVENTION

It is an object of the present invention to provide a protective cover having a configuration suitable to be applied to a variety of components or appliances for protecting the surface finish of the appliance and improving the grip on the appliance for the user.

It is yet another object of the present invention to provide a protective cover having a long service life and a simple to assemble configuration.

Further objects of the invention will be brought out in the following part of the specification, wherein detailed description is for the purpose of fully disclosing the invention without placing any limitations thereon.

### BRIEF DESCRIPTION OF THE DRAWING

With the above and other related objects in view, the invention consists in the details of construction and combination of parts as will be more fully understood from the following description, when read in conjunction with the accompanying drawings in which:

FIG. 1 illustrates a perspective view of a cover 10, in accordance with an embodiment of the present invention, wherein the cover 10 comprises a cover portion 12, a fastening portion 14, a fastening means 16 disposed on the fastening portion 14, and a cushioning means 18 disposed on the cover portion 12.

FIG. 2 illustrates another perspective view of the cover 10, in accordance with an embodiment of the present invention, wherein the cover 10 is shown to be partially folded, similar to the manner when it is to be assembled onto an appliance.

FIG. 3 illustrates a side view of a cutter 50 having a cover 10, in accordance with an embodiment of the present invention, applied on a handle of the cutter 50.

FIG. 4 illustrates a side view of a gun 60 having a cover 10, in accordance with an embodiment of the present invention, applied on various locations on the gun 60.

FIG. 5 illustrates a top view of the cover 10, in accordance with another embodiment of the present invention, wherein the cover 10 includes a filter 20 and a grippers 22.

FIG. 6 illustrates a perspective view of a cutter 70 having the cover 10, in accordance with an embodiment of the present invention, applied on various locations on the gun 70.

### DETAILED DESCRIPTION OF THE EMBODIMENTS OF THE INVENTION

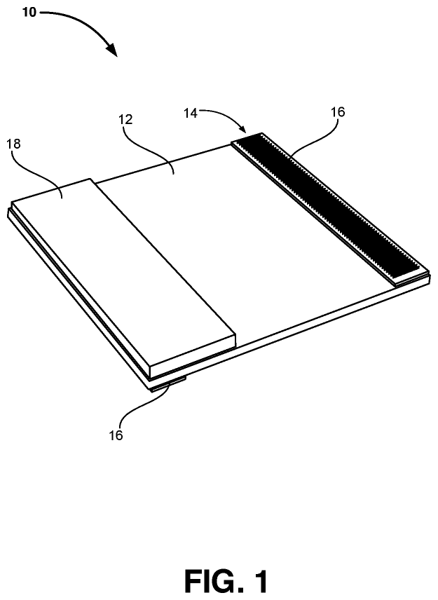

Referring now to FIG. 1 thru FIG. 6, where the present invention is generally referred to with numeral 10, it can be observed that a cover 10, in accordance with an embodiment of the present invention, comprises a cover portion 12, a fastening portion 14, a fastening means 16 disposed on the fastening portion 14, and a cushioning means 18 disposed on the cover portion 12.

The cover 10 comprises the cover portion 12. The cover portion 12 of the cover 10 is the portion of the cover 10 that forms a protective layer on top of the appliance on which the cover 10 is being applied. In an embodiment, the cover portion 12 of the cover 10 is made of a fire retardant material. According to one example, the cover portion can be made of at least one of polycarbonate, polypropylene, polyethylene, polyurethane sheets, and any combinations thereof. Other materials for the cover portion 12 having flame retarding properties and a flexibility to be formed into easily foldable sheets are well within the ambit of the present invention.

The cover 10 further comprises the fastening portion 14. In an embodiment, the fastening portion 14 can be configured on the cover portion 12 for fastening the cover 10 on an appliance. The cover 10 further comprises at least one fastening means 16. In accordance with the instant embodiment, the fastening means 16 are hook and loop straps. The fastening portion 14 can be provided along at least a section of the cover portion periphery. In some embodiments, the fastening portion 14 can be provided on the entire periphery of the cover portion 12.

It is to be noted that the fastening means 16 is not limited to be hook and loop fasteners. In another embodiment, the fastening means 16 can also include press fit buttons, snap fit buttons, rivets, and the like.

The cover 10 further comprises the cushioning means 18 disposed on the cover portion 12, wherein the cushioning means 18 is made of at least one of foam and rubber. Other materials of the cushioning means 18 can also include gel compositions being provided on the cover portion 12.

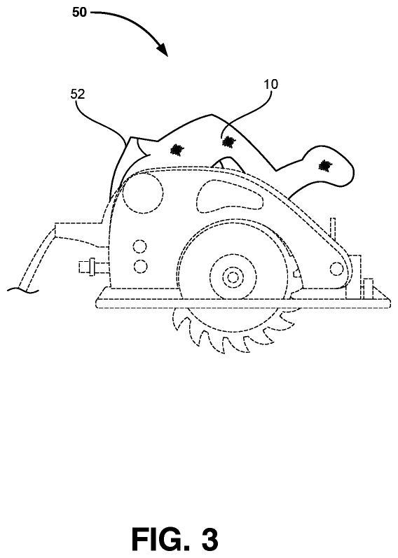

FIG. 3 illustrates a side view of a cutter 50 having a cover 10, in accordance with an embodiment of the present invention, applied on a handle 52 of the cutter 50. The material of the cover 10 has fire retardant properties, and as such the cover 10 is very durable. Furthermore, the use of the cover 10 provides the user with an enhanced grip.

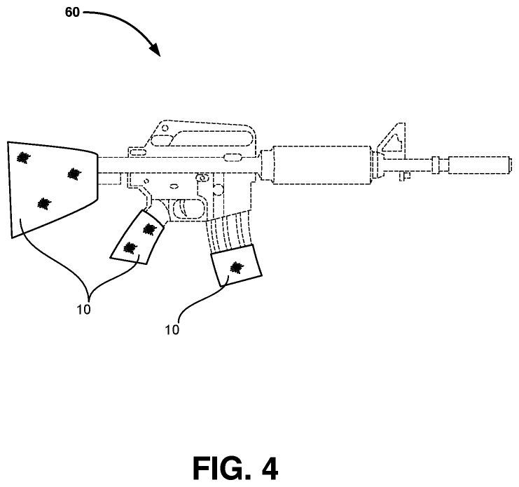

Similar to the cutter 50, as seen in FIG. 4, the cover 10 is applied to a gun 60 at various locations on the gun 60. These are typically the locations which come in direct contact with the user, and are thus susceptible to scratch formations. The application on the cover 10 protects and maintains the surface finish of the gun 60 while providing an enhanced grip to the user.

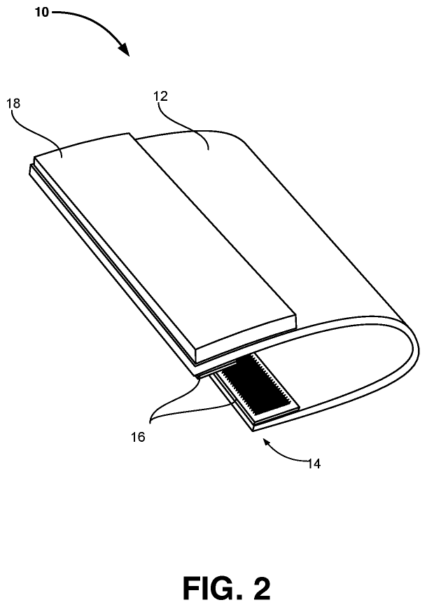

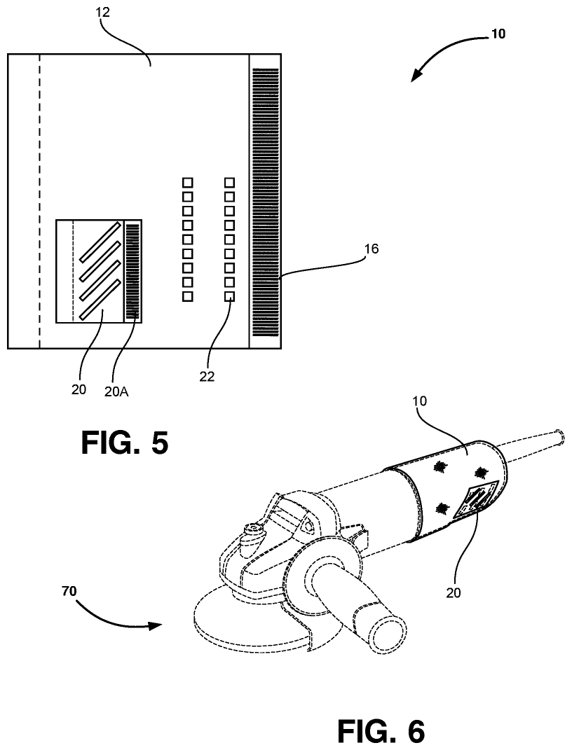

Another embodiment of the cover 10 is illustrated in FIG. 5. The embodiment illustrated in FIG. 5 is similar to the cover 10 illustrated in FIGS. 1 and 2, except the fact the cover 10 illustrated in FIG. 5 includes a filter 20 and grippers 22. As such, the explanation of like features of the cover 10 illustrated in FIG. 2 and FIG. 5 is not repeated again for the sake of brevity of the present document. Also, like elements in the covers 10 illustrated in FIG. 2 and FIG. 5 are referred by like numerals.

The filter 10, illustrated in FIG. 1, includes the filter 20 disposed on the cover portion 12. Handheld machines, for examples, drilling machines, cutters as seen in FIG. 6, and the like, include breathe vents. Particles may enter these vents, thereby causing damage to machines. In order to prevent this, the cover 10 includes the filter 20. The filter 20 is a replaceable filter and can be attached to the cover 10 via hook and loop fasteners 20A, in one embodiment. The cover 10 further includes grippers 22 configured on the cover portion 12 that enhance a user's grip on the handheld machine.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A cover comprising:
a. a cover portion; and
b. a fastening portion provided on the cover portion for fastening the cover on an appliance.

2. The cover according to claim 1, wherein the fastening portion comprises at least one fastening means.

3. The cover according to claim 2, wherein the fastening means are hook and loop straps.

4. The cover according to claim 1, wherein the cover portion is a sheet of a fire resistant material.

5. The cover according to claim 4, wherein the fastening portion is provided along at least a section of the cover portion periphery.

6. The cover according to claim 1, further comprising a cushioning means disposed on the cover portion.

7. The cover according to claim 6, wherein the cushioning means is made of at least one of foam and rubber.

8. The cover according to claim 4, wherein the fire resistant material is at least one of polycarbonate, polypropylene, and polyethylene.

9. The cover according to claim 1, further comprising a filter disposed on the cover portion.

10. The cover according to claim 9, wherein the filter is a replaceable filter.

11. The cover according to claim 9, further comprising at least one gripper configured on the cover portion.

12. A cover comprising:
a. a cover portion, wherein the cover portion is a sheet of a fire resistant material; and
b. a fastening portion provided on the cover portion for fastening the cover on an appliance:
i. wherein the fastening portion comprises at least one fastening means;
ii. wherein the fastening means are hook and loop straps;
iii. wherein the fastening portion is provided along at least a section of the cover portion periphery;
c. a cushioning means disposed on the cover portion, wherein the cushioning means is made of at least one of foam and rubber;
d. a filter disposed on the cover portion, wherein the filter is a replaceable filter; and
e. at least one gripper configured on the cover portion.

13. (canceled)
